(19) United States
(12) Patent Application Publication
(10) Pub. No.: US 2008/0144013 A1
(43) Pub. Date: Jun. 19, 2008

(54) System and method for co-registered hyperspectral imaging

(75) Inventors: Mark Allen Lanoue, Long Beach, MS (US); Robert E. Ryan, Diamondhead, MS (US); Duane O'Neal, Bay St. Louis, MS (US); Jeffrey A. Russell, Stennis Space Center, MS (US)

Correspondence Address: CROWELL & MORING LLP;INTELLECTUAL PROPERTY GROUP, P.O. BOX 14300, WASHINGTON, DC, 20044-4300, US

(73) Assignee: INSTITUTE FOR TECHNOLOGY DEVELOPMENT, Stennis Space Center, MS (US)

(21) Appl. No.: 11/987,574

(22) Filed: Nov. 30, 2007

Related U.S. Application Data
(60) Provisional application No. 60/861,953, filed on Dec. 1, 2006.

(51) Int. Cl. G01N 21/00

(52) U.S. Cl. 356/73

(57) ABSTRACT

Systems and methods for integration of fluorescence and reflective imaging are provided. The system and method can measure reflectance and fluorescence spectrally and spatially with co-registered hyperspectral signatures, and can output a co-registered image from first and second co-registered hyperspectral image data sets.

### CROSS-REFERENCE TO RELATED APPLICATIONS

The present application claims priority under 35 U.S.C. § 119 to U.S. Provisional Application No. 60/861,953, filed Dec. 1, 2006, the entire disclosure of which is herein expressly incorporated by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms Specific Cooperative Agreement No. NNS05AB56A awarded by the National Aeronautics and Space Administration (“NASA”).

### BACKGROUND OF THE INVENTION

Detection of plant stress is of importance to a variety of endeavors ranging from the autonomous growing of plants in space to terrestrial-based greenhouses. Conventionally, such detection is performed using reflectance spectroscopy in which the reflectance is estimated from knowledge of the spectral content of the input illumination and measurement of the reflected spectrum from the surface of interest. The shape of the reflectance spectra can be used to detect plant stress.

### SUMMARY OF THE INVENTION

Typically reflective transmission (ultraviolet through infrared) and fluorescence hyperspectral imaging have been used independently to study and evaluate surface properties of a large variety of materials. Each spectral imaging method examines complimentary spectroscopic phenomena that can be used to study morphological and molecular properties. Application of these technologies include: biomedical, forensic, counterfeiting detection, plant stress detection and materiel research.

In general, however, it has been difficult to combine reflectance or fluorescence imaging spectroscopy because the instrumentation does not easily allow the near simultaneous measurement of reflective and fluorescence signatures. As a result, very little work has been performed exploring the benefit of using both hyperspectral reflective and fluorescence signatures in combination. The integration of these two hyperspectral signatures may make it possible to detect and discriminate characteristics or changes not previously observable.

Plant stress detection with hyperspectral imaging can be a valuable technique. When light strikes a leaf it can be transmitted, reflected, or absorbed. As a result, reflectance is only one component of the total optical chain. In the case of absorption, the light energy can generate heat, be used for photochemical processes, or produce fluorescence. Diseases, toxic compounds, and other stress effects cause changes in the plant surface and internal structure. They also cause accumulation of secondary metabolites, and the breakdown of photosynthetic pigments. Any of these phenomena affect optical properties of the leaves.

Reflective band imaging is the most mature and commonly used technology for monitoring plant stress, producing spectral evidence of change. Thermography and fluorescence are less developed technologies, but have been shown in a research setting to yield additional unique information for detecting a variety of plant stresses. In the case of fluorescence, the relative visible-to-near infrared (NIR) fluorescence is an indicator of photosynthetic activity, while increased blue and green fluorescence is an indicator of abiotic or biotic stress.

Over the last decade, a large amount of research on multispectral fluorescence imaging has shown great promise in detecting a variety of pre-visual plant stresses (See, for example, Lichtenthaler, H. K., Miehe, J. A., 1997. Fluorescence imaging as a diagnostic tool for plant stress. Trends in Plant Science 2, 316-320). In these systems an active source, such as discharge lamps, Black lamps, Ultraviolet (UV) lasers or blue light emitting diodes (LEDs), are used to excite the fluorescence. This work, however, does not address the utility of combining hyperspectral reflectance signatures with fluorescence signatures to provide higher confidence information. In addition, although hyperspectral fluorescence spectroscopy has been applied at the point level, it has not been applied at the imaging level. There are many advantages of hyperspectral reflective imaging, and similar benefits may be achievable using hyperspectral fluorescence imaging over point level data collection.

Using plants as an example, several studies have shown that in general it is difficult to diagnose a specific cause of stress in a plant using reflective or fluorescence spectroscopy. The fluorescence studies used multispectral sensors equipped to capture specific bands in the visible and near-infrared region of the electromagnetic spectrum. Therefore, in such studies the spectral component is limited because only a sample of the total fluorescence energy in the visible and near-infrared region is collected. This would be the case regardless of the object/subject. Imaging the details of leaves has been shown to be very useful in helping identify various types of stress. In systems where extremely high signal-to-noise ratios are possible, such as the present invention, it may be possible to detect and identify stresses in biological systems that were not previously detectable.

Exemplary embodiments of the present invention provide a hyperspectral imaging instrument that utilizes tailored artificial lighting, and enables the capability to measure both reflectance and fluorescence, spectrally and spatially co-registered. This dual spectral imaging capability enables the optimization of reflective, fluorescence spectra under a variety of illuminations (using built-in artificial light sources), and fused data sets. The dual spectral imaging capability of the present invention enables the optimization of reflective, fluorescence, and fused data sets as well as the design of cost effective multispectral solutions. Spatially co-registered data sets minimize post processing resampling typically required for multimode spectral imaging systems. Furthermore, in many cases fluorescence spectra produce uncorrelated vector spaces to reflectance imaging, which allows for increased discrimination.

Exemplary embodiments of the present invention provide spatially co-registered images by incorporating a fluorescence component with a reflective imaging hyperspectral sensor. This can be achieved by characterizing a visible/near-infrared hyperspectral sensor to provide data to optimize the sensor's performance for both reflectance and fluorescence imaging. A uniform illumination source based on a LED illuminated integrating sphere can be employed. Alternatively, any relatively uniform light source with the proper spectral components can be employed. Furthermore, a non-uniform light source can be employed with an imaging system with a spectrally flat reflective target to calibrate out non-uniformities.

In accordance with exemplary embodiments of the present invention, an imaging method involves illuminating an object and capturing radiation emanating from the object, the radiation comprising alternately reflectance radiation and fluorescent radiation. The reflectance radiation is input into a first hyperspectral imager, thereby generating a first hyperspectral image signature that characterizes the object, based on the reflectance radiation. The fluorescent radiation is input into a second hyperspectral imager, thereby generating a second hyperspectral image signature that characterizes the object, based on the fluorescent radiation. A co-registered image of the first and second hyperspectral image signatures is output.

An exemplary imaging method can also involve illuminating an object and capturing radiation emanating from the object. Based on the captured radiation, first and second co-registered hyperspectral image data sets that characterize the object are generated, the first hyperspectral image data set being generated from reflectance radiation emanating from the object, and the second hyperspectral image data set being generated from fluorescent radiation emanating from the object. The first and second co-registered hyperspectral image data sets can then be output.

An exemplary imaging method can further involve illuminating an object and scanning the object to detect both reflectance and fluorescent radiation emanating from the object. The scanning step comprises inputting both the reflectance radiation and the fluorescent radiation alternately into a hyperspectral scanner, whereby co-registered hyperspectral signatures are generated respectively for the reflectance radiation and the fluorescence radiation. The generated co-registered hyperspectral signatures for the reflective and fluorescence radiation can then be output.

Other objects, advantages and novel features of the present invention will become apparent from the following detailed description of the invention when considered in conjunction with the accompanying drawings.

### BRIEF DESCRIPTION OF THE DRAWING FIGURES

The patent or application file contains at least one drawing executed in color. Copies of this patent or patent application publication with color drawing(s) will be provided by the Office upon request and payment of the necessary fees.

FIG. 1A illustrates an exemplary imaging system in accordance with the present invention;

FIG. 1B illustrates an exemplary method in accordance with the present invention;

FIG. 2 illustrates the spectra for reflective combination and fluorescence imaging along with device parameters;

FIG. 3 illustrates a plant placed within the 41-inch sphere in accordance with exemplary embodiments of the present invention;

FIG. 4 is a three band simulated color image of a healthy lettuce plant;

FIG. 5 is a NDVI false color image of the healthy, control, lettuce plant;

FIG. 6 is a gray scale image generated from the ratio of 740/684 nanometers;

FIG. 7 is a three band simulated color image of an unhealthy lettuce plant that has been treated with acid;

FIG. 8 is a NDVI false color image of the unhealthy, acid treated, lettuce plant; and

FIG. 9 is a gray scale image generated from the ratio of 740/684 nanometer bands.

### DETAILED DESCRIPTION OF THE PREFERRED EMBODIMENTS

Exemplary embodiments of the present invention provide high spatial resolution hyperspectral imagery in both the reflective and fluorescence domain, which may help identify specific differences and changes in an object, such as biological systems and homeostasis. By employing a single hyperspectral imager for detecting the reflective and fluorescence signal, the post-processing of spectral and spatial registration is minimized. In addition, the types of data sets provided by the present invention can aid in the definition of future hardware systems that are optimized for specific problems through spectral band selection, mode of operation, and spatial resolution optimization.

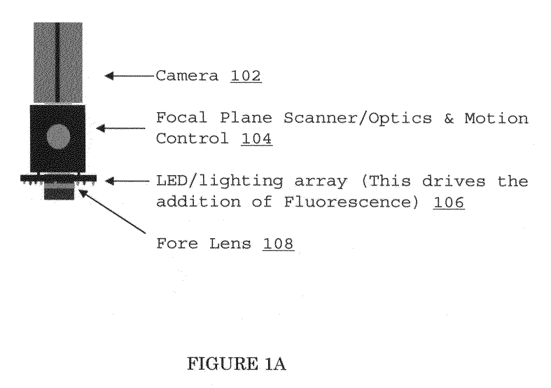

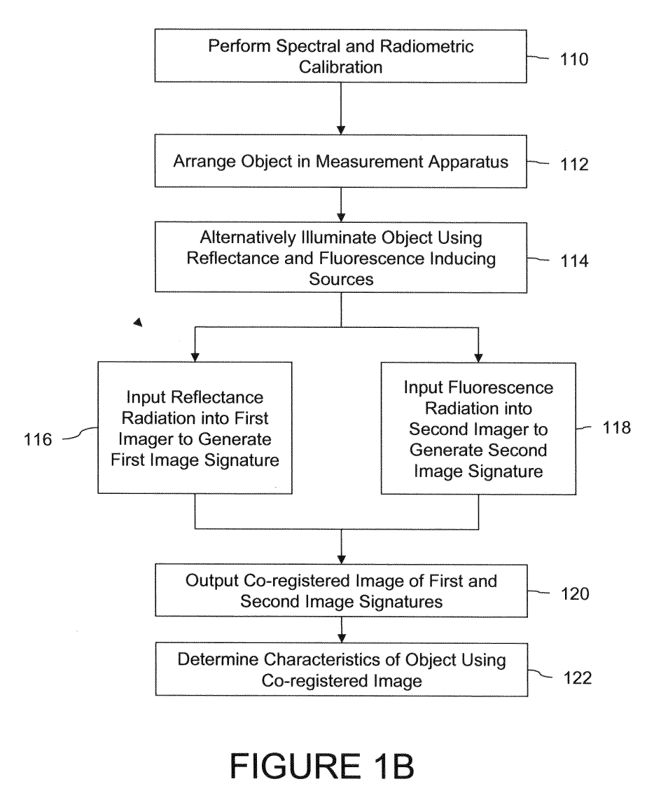

FIG. 1A illustrates an exemplary system in accordance with the present invention. The system includes a camera 102, focal plane scanner/optics and motion control 104, an LED/lighting array 106 and a fore lens 108. As will be described in more detail below, an object that is to be imaged is placed inside of an integrating sphere and the system of FIG. 1 is mounted on the sphere such that the LED/lighting array 106 illuminates the object to be imaged and camera 102 captures the illuminated object. Camera 102 can be any camera system that can mimic a multi-spectral or hyperspectral imaging system.

LED/lighting array 106 can be a ring, or array, of LED's surrounding the imaging fore optics of the hyperspectral imager. The LEDs can include, for example, red LED's that can serve primarily as a nutrient/energy source for the biological system, as well as a white and other specific excitation wavelengths that may prove very attractive for this system because of stringent energy efficiency requirements. In accordance with exemplary embodiments of the present invention, natural light can be supplemented with a modulatable UV or blue LED light source (of any appropriate discrete narrow band) to induce fluorescence that can be detected with a visible and near infrared (VNIR) hyperspectral system, such as that disclosed in U.S. Pat. No. 6,166,373, the entire disclosure of which is herein expressly incorporated by reference. The lighting system has a spectral range that extends into the Near Infrared (e.g., out to at least 800 nm) in order to measure reflectance data that are important in specific biological systems such as plants, but not exclusively to plants. For other applications the light source and imager are selected to cover the spectral range of interest. When the present invention is employed for studying objects other than plants, the spectral range of the lighting system can be adjusted accordingly.

Each spectral type of LED can be turned on or off depending on the specific remote sensing/imaging process being performed. The lights can be controlled via computer/software control or via external and manual triggers. Alternative light sources and/or optical filters can also be used in place of, or in conjunction with, the above LED setup in order to obtain the use of reflective and fluorescence hyperspectral imaging. Accordingly, both reflective and fluorescence signals can be measured through a differencing process by turning a narrow blue, ultraviolet light or white light LED source on and off.

Optimization of plant growth under artificial illumination is an important consideration for a variety of purposes. Artificial illumination is used to grow plants where light is not available and to control and minimize undesirable variations that can affect plant growth under natural illumination conditions. Several illumination characteristics for plant growth need to be considered which include the spectral content, irradiance or Photosynthetic Active Radiation (PAR) level, spatial uniformity and shading potential.

Light field spatial uniformity, or the lack of it, affects the growth rate degree of variability. Because LEDs sources are directional in nature and emit light in a specific direction, these sources can be arranged in arrays placed above a plant canopy to illuminate canopy. For most types of plants different wavelength LEDs (typically blue and red) need to be integrated into the array to provide the needed spectral distribution. The discrete LEDs should be arranged into a pattern that produces uniform illumination with the proper spectral distribution. In cases where there is a desire for a large number of wavelengths the design and fabrication of the LED array can be complex and expensive. Although light uniformity has been described in connection with plant growth, light uniformity can also be useful when other types of objects are employed with the present invention. Moreover, when light uniformity is not provided, the equipment can be calibrated to eliminate or minimize any variability of the lighting.

For many types of plants array lighting placed above the plant canopy produces large shadow fractions reducing the amount of light available for photosynthesis. Recent diffuse illumination studies have shown that complex plant canopies can benefit from diffuse illumination since the amount of shadowing is minimized. Shadowing from direct illumination also affects the quality of an imaging systems ability to monitor a canopy or plant health.

One issue is the provision of a uniform illumination source with an adjustable spectral content necessary to produce adequate reflection. Although an array of LEDS could produce uniform illumination, there would always be some shadowing. In accordance with exemplary embodiments of the present invention, this issue can be addressed by placing small line arrays of LEDs in a large integrating sphere to produce excellent illumination. The lighting system exploits highly diffuse reflective surfaces on the interior of a sphere, hemisphere or other nearly enclosed structures to help uniformly mix discrete light sources and produce highly uniform illumination.

A set of light sources are placed on the sphere or illuminated through a single or multiple small ports on the outer surface. An object to be imaged, such as plant or set of plants, is placed inside the sphere or enclosure. The light sources are situated inside the sphere or enclosure so the light produced by them will be multiply scattered before illuminating the plants. The light sources can be baffled if necessary to minimize any direct illumination. The light sources can be almost any type of light source that can be used for plant growth. When the present invention is employed with objects other than plants, other types of light sources can be employed. The sources can be modulated to optimize photosynthesis. Wavelengths beyond the PAR (400-700 nm) range can be added for plant diagnostics or growth regulation. In a system with high reflectivity and limited losses other than the plant photosynthetic surfaces, the plant photosynthetic surfaces become the dominant absorption surfaces. The irradiance H for any wavelength inside an integrating sphere is given by

$$H = \frac{{Φ}_{I}}{{A}_{S}} \frac{ρ ( 1 - f )}{1 - ρ ( 1 - f )}$$

Where Φₗ is the input power at a specific wavelength, A_{S} is the sphere surface area, ρ is the surface reflectance and f is the fraction of power lost. As the reflectance approaches unity and fraction of the power lost is dominated by the plant surfaces the irradiance approaches input power divided by the effective plant surface. This fact optimizes the use of the lighting for growing the plant and imaging them. It also reduces the amount of input light needed for imaging.

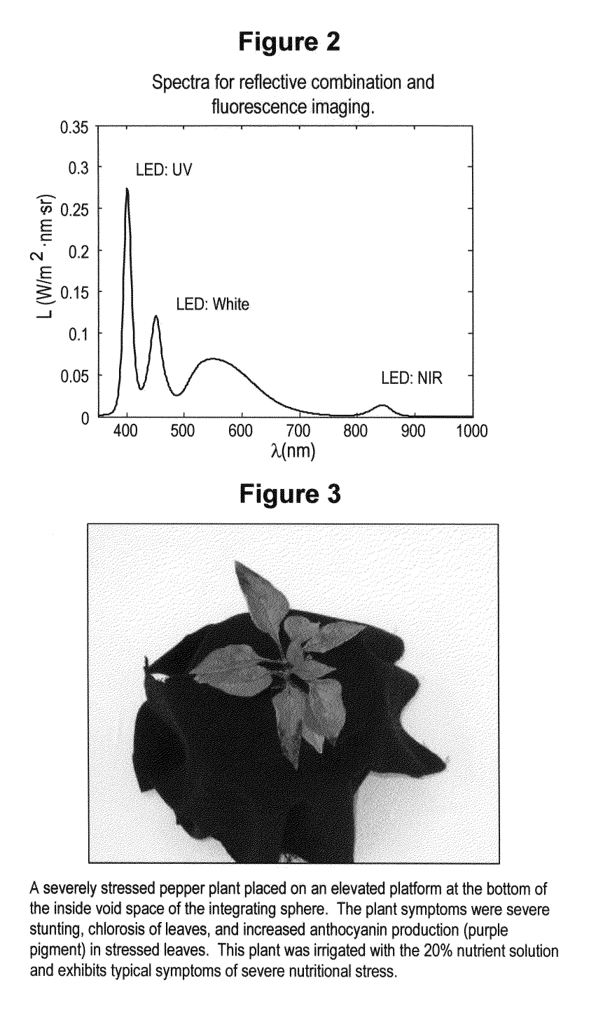

Exemplary embodiments of the present invention employ a combination of blue, white and NIR LEDs produce the necessary spectra for reflective and fluorescence imaging. All LEDs are used for reflective imaging, and only blue LEDs are used for fluorescence imaging. The NIR LED is added to help produce Color Infrared or Normalized Difference Vegetation Indices (NDVI) the spectra for reflective combination and fluorescence imaging along with device parameters are shown in FIG. 2. In the Fluorescence mode, the White and NIR LEDS are turned off while the UV is on. The characteristics of the various LEDs are listed in Table 1, 2 and 3.

TABLE 1
White Light LED specification

| Color; Manufacturer; Model | White; Luxeon; LXHL-LW6C |
|---|---|
| Volts [V]; Current [mA] | 6.8; 700 |
| Radiance [W/(m2 · sr)]; | 12.09; 176 |
| Flux [mW] | |
| Luminous Flux [lm] | 120 |
| Center Wavelength [nm] | 452.16; 559.0 |
| FWHM [nm] | 31.67; 143.14 |

TABLE 2
Blue LED specification

| | |
|---|---|
| Color; Manufacturer; Model | UV; CREE; 7090 |
| Volts [V]; Current [mA] | 4.0; 3.5 |
| Radiance [W/(m2 · sr)]; | 4.82; 200 |
| Flux [mW] | |
| Luminous Flux [lm] | .05 |
| Center Wavelength [nm]; | 403.11; 18.28 |
| FWHM [nm] | |

TABLE 3
NIR LED specification

| | |
|---|---|
| Color; Manufacturer; Model | IR; LEDTRONICS; |
| | L200CWIR851 |
| Volts [V]; Current [mA] | 1.6; 20 |
| Radiance [W/(m2 · sr)]; | .71; 12.3 |
| Flux [mW] | |
| Luminous Flux [lm] | N/A |
| Center Wavelength [nm]; | 840.67; 42.52 |
| FWHM [nm] | |

Although the tables above identify particular types of LEDs, the present invention can be employed with other LEDs, for example, from other manufacturers.

FIG. 1B illustrates an exemplary method in accordance with the present invention. In order to optimize the capture and quality of reflective and fluorescence imaging the basic imaging system should be characterized and calibrated (step 110). An exemplary imager, such as the Institute for Technology Development's (ITD) VNIR10E pushbroom hyperspectral imager, comprises an imaging foreoptic, Focal Plane Scanner (FPS), dual prism grating spectrograph and a CCD detector read out. The system can take 1200 spectra from 400-1000 nm for 1600 distinct spatial pixels. With the FPS, several hundred lines of imaging can be recorded without moving the image object or the spectrograph. This type of system requires both spectral and radiometric calibration. The spectral calibration assigns wavelengths to the spectra recorded for the distinct pixels. The radiometric calibration converts the digital counts at each wavelength to radiance engineering units. The radiometric calibration is useful in producing absolute numbers for determining reflectance and fluorescence efficiencies, and also for correcting vignetting.

The spectral calibration comprises imaging a laser illuminated 30 cm diameter Optronics Spectralon coated integrating sphere. An integrating sphere is a nearly spherical structure usually coated with highly reflective materiel such as BaSO4, Spectralon™ or other materials that have nearly unity reflectance Lambertian scattering properties with high reflectance. The sphere can have an opening, that is, for example, a 10 cm diameter, through which a series of gas lasers and diode lasers illuminate the side of the integrating sphere. Through multiple bounces these narrow band sources uniformly illuminate a baffle inside the sphere which the imager views and records data. A series of Helium Neon and Argon Ion laser lines can be employed as primary wavelength standards. The diode lasers can be measured and calibrated using, for example, a Burleïgh Wavemeter. In some cases the laser wavelengths are known to better than 1 part in a million. Each laser is turned on in sequence and the laser spectrum is recorded for each of the 1600 spatial pixels. The individual laser spectra are then fitted to Gaussian functions that determine the center and width of the laser line. Each of these values is then used to develop and assign a spectral calibration to each of the spatial pixels. Although a particular type of calibration has been described here in detail, other types of calibration can be employed.

The object to be analyzed is then inserted into the measurement apparatus (step 112). Exemplary embodiments of the present invention can employ, for example, a 41-inch diameter Spectralon™ coated integrating sphere as the measurement apparatus. The sphere could be split in half, and an object to be imaged, such as a plant is placed in the lower half of the sphere. In an 8-inch diameter port on the top of the sphere, the hyperspectral imager can be placed and used to image the plant below.

Next, a Tungsten Halogen lamp is turned on in the 30 cm integrating sphere and imager is set to record images (steps 114-118). This source produces a continuum spectrum covering the spectral region of interest and beyond. An exemplary sphere can have its radiance across the spectral range of interest known to better than 2% one-sigma, and the spatial uniformity across the integrating sphere field-of-view known to be better than 1%. For each focal plane scanner position the integrating sphere is imaged. This data is then processed using the assigned wavelength calibration and used to produce radiometric calibration coefficients for each pixel, wavelength and FPS position.

Since the expected fluorescence signal can be very small compared to the reflective signal, the spectra can be examined at several resolutions. An exemplary CCD camera employed by the present invention can perform spectral binning of the individual detector photosites in hardware. Adequate spectra may be acquired at a spectral binning of 8 detectors, which is equivalent to increasing the integration time by a factor of 8. This spectral binning can produce nominally spectral resolution of 5 nm, which is more than adequate to resolve all features of interest. A wavelength calibration at this binning can be produced and applied to all subsequent data sets. Spatial binning need not be applied to maintain the maximum spatial resolution. As an alternative to, or in addition to, using spectral binning to obtain higher sensitivity, increasing the brightness of the excitation source and/or increasing integration time can be employed to obtain higher sensitivity.

In accordance with exemplary embodiments of the present invention, the object is alternatively illuminated with a reflective inducing radiation source (e.g., a combination of three LEDs) and a fluorescence inducing radiation source (e.g., solely a blue LED illumination) (step 114). When the object is illuminated with the reflective inducing radiation source, reflective measurements are performed by a first imager to generate a first image signature (step 116). When the object is illuminated only by the fluorescence inducing radiation source, fluorescence measurements are performed by a second imager to generate a second image signature (step 118). The first and second imager can be the same instrument in the form of a hyperspectral scanner. The output of the two image signatures is a co-registered image (step 120), which can be used for determining the characteristics of the object (step 122). The co-registered image can be output to any number of difference devices, including, but not limited to, a printer, a display and/or the like. As part of the integration process a set of quick-look products can be employed, where these quick-look products are a series of multispectral bands integrated over small spectral regions. The products include a standard RGB and NDVI reflectance images, 684 nm fluorescence, 740 nm fluorescence and a 740 nm/680 nm ratio fluorescence image.

FIGS. 3-9 illustrate images obtained using a large 1.1 m diameter integrating sphere. Plants were placed within the 41-inch sphere at the bottom (FIG. 3) and the top replaced. The LED lighting system was reconnected and the camera system placed on top. Spectral files were collected that represented induced fluorescence of the plant canopies and leaves under blue LED excitation, and hyperspectral data collected under white LED illumination.

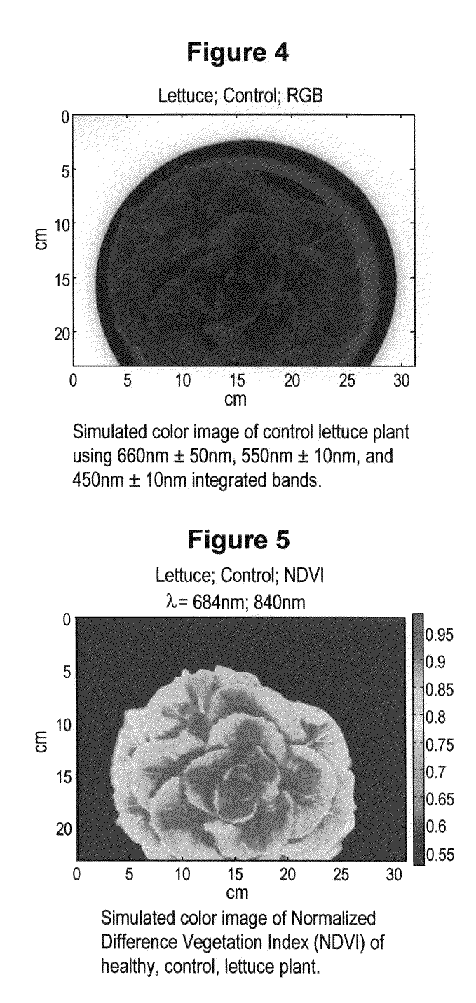

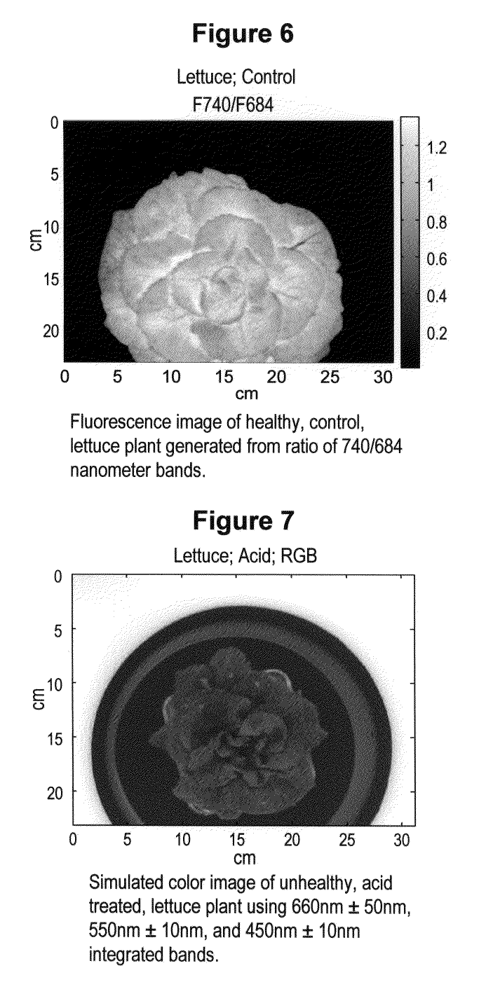

FIG. 4 is a three band simulated color image of a healthy lettuce plant acting as the control for the experiment. FIG. 5 is a NDVI false color image of the healthy, control, lettuce plant. NDVI is Normalized Difference Vegetation Index and is a measure of plant greenness or health for reflective imaging, which is one multi-spectral technique in this case using hyperspectral data. FIG. 6 is a gray scale image generated from the ratio of 740/684 nanometers. This ratio is commonly used for fluorescence stress detection. Plant regions under stress have ratio values near the low end of the scale. Plant regions not under stress have ratio values near the high end of the scale.

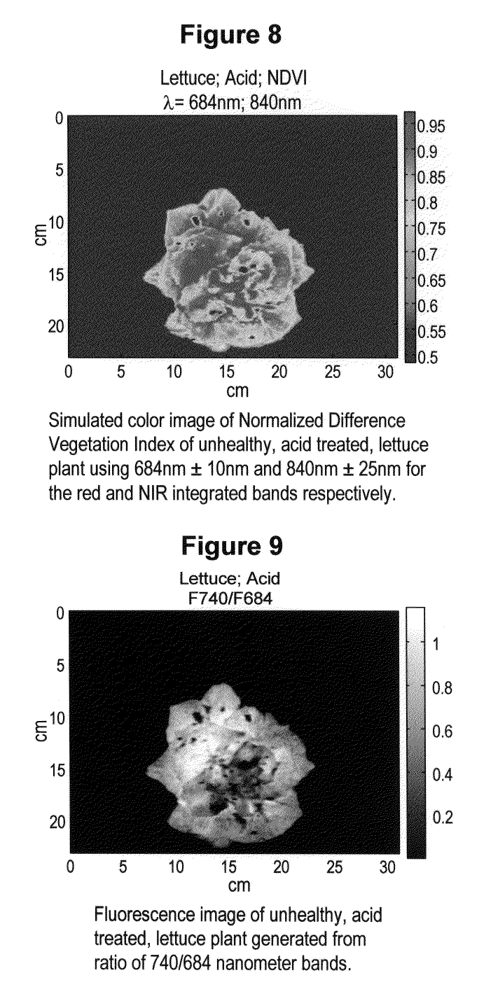

FIG. 7 is a three band simulated color image of an unhealthy lettuce plant that has been treated with acid. FIG. 8 is a NDVI false color image of the unhealthy, acid treated, lettuce plant. FIG. 9 is a gray scale image generated from the ratio of 740/684 nanometer bands. The arrows point to leaves that are showing stress.

Although exemplary embodiments of the present invention have been described as employing particular types of lighting, such as a combination of particular lights to produce reflectance and only blue LEDs to induce fluorescence, the present invention can also employ any type of lighting sources that can produce reflectance and any type of lighting sources that can produce fluorescence. Moreover, although exemplary embodiments have been described in connection with a LED illuminated integrating sphere, any relatively uniform light source with the proper spectral components can be employed. Furthermore, a non-uniform light source can be employed with an imaging system with a spectrally flat reflective target to calibrate out non-uniformities.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An imaging method comprising:
illuminating an object;
capturing radiation emanating from said object, said radiation comprising alternately reflectance radiation and fluorescent radiation;
inputting said reflectance radiation into a first hyperspectral imager, thereby generating a first hyperspectral image signature that characterizes said object, based on said reflectance radiation;
inputting said fluorescent radiation into a second hyperspectral imager, thereby generating a second hyperspectral image signature that characterizes said object, based on said fluorescent radiation; and
outputting a co-registered image of the first and second hyperspectral image signatures.

2. The imaging method according to claim 1, wherein:
said first and second hyperspectral imagers comprise the same instrument in the form of a hyperspectral scanner; and
said reflectance radiation and said fluorescent radiation are input alternately to said hyperspectral scanner.

3. The imaging method according to claim 2, wherein said illuminating step comprises alternately illuminating said object with white light and with radiation that stimulates fluorescence in said object.

4. The method of claim 1, further comprising:
calibrating the first and second hyperspectral imagers.

5. The method of claim 1, further comprising:
determining a characteristic of the object using the co-registered image.

6. The method of claim 1, further comprising:
arranging the object in a measurement apparatus.

7. The method of claim 6, wherein the measurement apparatus is an integrating sphere.

8. The method of claim 1, wherein the object is a plant.

9. An imaging method comprising:
illuminating an object;
capturing radiation emanating from said object;
based on said captured radiation, generating first and second co-registered hyperspectral image data sets that characterize said object, said first hyperspectral image data set being generated from reflectance radiation emanating from said object, and said second hyperspectral image data set being generated from fluorescent radiation emanating from said object; and
outputting the first and second co-registered hyperspectral image data sets.

10. The imaging method according to claim 9, wherein said illuminating step comprises alternately illuminating said object with white light and with radiation that stimulates fluorescence in said object.

11. The method of claim 9, further comprising:
calibrating a hyperspectral imager that captures the radiation.

12. The method of claim 9, further comprising:
generating a co-registered image from the first and second co-registered hyperspectral image data sets; and
determining a characteristic of the object using the co-registered image.

13. The method of claim 9, further comprising:
arranging the object in a measurement apparatus.

14. The method of claim 13, wherein the measurement apparatus is an integrating sphere.

15. The method of claim 9, wherein the object is a plant.

16. An imaging method, comprising:
illuminating a object; and
scanning said object to detect both reflectance and fluorescent radiation emanating from the object, wherein said scanning step comprises inputting both said reflectance radiation and said fluorescent radiation alternately into a hyperspectral scanner, whereby co-registered hyperspectral signatures are generated respectively for said reflectance radiation and said fluorescence radiation; and
outputting the generated co-registered hyperspectral signatures for said reflectance and fluorescence radiation.

17. The imaging method according to claim 16, wherein said illuminating step comprises alternately illuminating said object with white light and with radiation that stimulates fluorescence in said object.

18. The method of claim 16, further comprising:
calibrating a hyperspectral imager that scans the object.

19. The method of claim 16, further comprising:
generating a co-registered image from the first and second co-registered hyperspectral image data sets; and
determining a characteristic of the object using the co-registered image.

20. The method of claim 16, further comprising:
arranging the object in a measurement apparatus, wherein the measurement apparatus is an integrating sphere.
